(19) United States
(12) Patent Application Publication
(10) Pub. No.: US 2005/0254136 A1
(43) Pub. Date: Nov. 17, 2005

(54) Display system

(76) Inventors: Tommy Blomqvist, Linkoping (SE); Krister Stenberg, Linkoping (SE); Jorgen Larsson, Linkoping (SE); Jimmie Karlsson, Linkoping (SE); David Svenmar, Linkoping (SE)

Correspondence Address: SWIDLER BERLIN LLP, 3000 K STREET, NW, BOX IP, WASHINGTON, DC, 20007, US

(21) Appl. No.: 11/088,807

(22) Filed: Mar. 25, 2005

(30) Foreign Application Priority Data
Mar. 25, 2004 (EP) 04007153.2

(51) Int. Cl. G02B 27/14

(52) U.S. Cl. 359/630

(57) ABSTRACT

A display system in a fighter aircraft including a helmet mounted display device and a helmet support unit. The helmet mounted display device is arranged to provide information on a visor of the helmet. The helmet support unit is arranged to interconnect the display system with a system computer and a power source in the aircraft. The the helmet support unit includes a high voltage power supply and the helmet support unit is arranged in a holder on a garment of the pilot.

### FIELD OF THE INVENTION

The present invention relates to a display system in a fighter aircraft including a helmet mounted display device and a helmet support unit.

### BACKGROUND OF THE INVENTION

A display system including a helmet mounted display device is more and more considered as a required system in a modern fighter aircraft. This type of system improves situation awareness for the pilot by presenting information on the visor of the helmet.

A display system according to the state-of the art includes a helmet mounted display device and a helmet support unit. The helmet mounted display device may be based on the technique with cathode ray tubes. The helmet support unit includes equipment supporting the functionality in the helmet mounted display device. Such equipment may include a high-voltage power supply for the CRT display, a graphic generator, a memory card and a connector for interfacing the display system with e.g. a system computer in the aircraft. Part of the support equipment may be specifically adapted to a specific display device, e.g., the high-voltage power supply may be tuned to the CRT in the helmet mounted display device.

The helmet mounted display device and the helmet support unit are interconnected by means of a high voltage connection when the display system is in operation. The display system also includes a connection to the aircraft. Disconnection of the high voltage connection during operation is undesirable since disconnection may lead to an arc being drawn during the disconnection process. High voltage connectors are also undesirable since they are more complex with increased maintenance. To increase safety and active-duty fitness it is therefore desirable that disconnection takes place in a low voltage cable during emergency situations as well as during normal use.

U.S. Pat. No. 5,596,491 discloses a helmet mounted display system. A first module including a high voltage power supply is mounted on the helmet. A second module including support equipment is connected to the first module by means of a low voltage connection. The disclosed system achieves a safe connection between the pilot and the high-voltage power required for the CRT display device. However, a draw-back with the disclosed system is that it provides increased head worn mass and increased size, which is considered to be a hazard in particular during ejection from the aircraft and also a risk for fatigue injuries due to long use.

The object of the invention is to achieve a display system where the pilot's head worn mass is reduced whilst assuring correct association between a helmet support unit and a helmet mounted display device. Another object of the invention is to provide a display system with a helmet mounted display device having a high voltage supply which can be carried safely by a person in the case that the connection to the aircraft should be broken.

### DESCRIPTION OF THE INVENTION

These objects are achieved through the display system disclosed in claim 1. In accordance with the invention a helmet support unit includes a high voltage power supply. The helmet support unit is arranged in a holder on the garment of the pilot.

In accordance with a preferred embodiment of the invention the helmet support unit and the helmet mounted display device are integrated by means of a flexible extension. The helmet support unit further includes a quick release connector for detachably connecting the helmet support unit to a connector on a connection cable for connection with the aircraft.

In accordance with a specific embodiment of the invention, the quick release connector is arranged to be released from the aircraft connector when subjected to a pulling force exceeding a first predetermined level.

In accordance with yet another embodiment of the invention, an emergency coupling is arranged in the flexible extension which integrates the helmet mounted display device and the helmet support unit. The emergency coupling is arranged to be disconnected at a pulling force exceeding the first predetermined level at least by a factor two.

In accordance with an embodiment of the invention the helmet support unit includes a high-voltage power converter, a graphic editor and a memory card.

In accordance with a preferred embodiment of the invention the helmet support unit is arranged in a holder on the garment of the pilot. Such a holder may e.g. be a front pocket on the pilot's garment, the pocket being placed on the torso. It may also be any type of clip attached to the garment.

In another embodiment of the invention the helmet support unit includes cooling means in a back portion of the unit, which portion interfaces with the pilot.

In yet another embodiment of the invention, the helmet support unit includes isolation means in the back portion of the unit where the unit interfaces with the pilot.

The display system according to the invention has the advantage that it reduces the weight in the helmet without introducing the risk of having a separation in the high voltage connection to at least one CRT in the helmet mounted display device.

A further advantage of the invention is that separation of the display system from the aircraft may be achieved through separation in a quick release connector alone; no further separations are required during e.g. ejection from the aircraft. The display system is well adapted for a situation when a quick exit from the aircraft must be performed.

Another advantage of the invention is that there are no free-hanging cables or load after separation of the display system from the aircraft.

Yet another advantage is that the risk of foreign object damage is kept on a low level, since a major part of the equipment in the display system may be removed from the aircraft when not in use. This is also preferable from a weight limitation aspect.

A further advantage of the invention is that the display system easily may be retrofitted into an existing aircraft configuration. The system is particularly suitable for cockpits with limited space.

### BRIEF DESCRIPTION OF THE DRAWINGS

FIG. 1. discloses a pilot with a display system in accordance with the invention

### DETAILED DESCRIPTION OF PREFERRED EMBODIMENTS

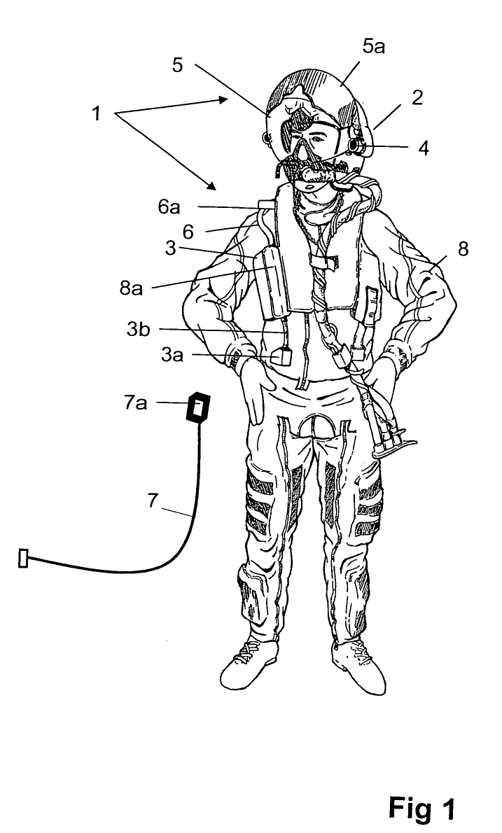

The present invention will be described in relation to the embodiment illustrated in FIG. 1, wherein a display system 1 including a helmet mounted display device 2 and a helmet support unit 3 is illustrated. The helmet mounted display device 2 includes at least one cathode ray tube (CRT) 4 which projects an image onto a visor 5a of a helmet 5. The CRT requires a high voltage supply which must be provided without impairing the safety in the cockpit.

The helmet mounted display device 2 is supported by equipment arranged in the helmet support unit 3. In order to maintain the weight of the helmet 5 mounted parts of the display system 1 on a lowest possible level, all equipment that is not required for the generation of the image is removed from the helmet 5 and arranged in the helmet support unit 3. This equipment includes a high voltage signal source, a graphic generator, a memory card and a quick release connector 3a. The helmet support unit 3 and the helmet mounted display device 2 are interconnected by means of a flexible extension 6. This flexible extension 6 may be achieved through any type of flexible cable or other type of connection that is attached to the helmet mounted display device 2 and to the helmet support unit 3 in such a way that it resists the pulling forces that may occur during separation of the pilot from the aircraft. From a configuration point of view, the helmet mounted display device 2 and the helmet support unit 3 are configured as one entity, even though the flexible extension 6 between the helmet mounted display device 2 and the helmet support unit 3 enables physical adjustment of the helmet support unit 3 in relation to the helmet mounted display device 2.

The high voltage power unit, graphic generator and memory card may be uniquely adapted to a specific helmet mounted display device 2. This applies in particular to the relationship between a specific high voltage power unit and the image generator in the form of at least one CRT. In order not to deviate from required settings, a specific helmet support unit 3 should therefore always be associated with the same helmet mounted display device 2. With the configuration disclosed in FIG. 1, disconnection between the helmet support unit 3 from the helmet mounted display device 2 is only considered as an measure in an emergency situation, e.g., when during activation of the ejection seat, the helmet and the pilot are separated. An emergency coupling 6a in the flexible extension between the helmet mounted display device 2 and the helmet support unit 3 is arranged to be released when subjected to a high pulling force.

The helmet support unit also includes a man-portion quick release connector 3a, which connects the unit to a corresponding aircraft quick release connector 7a on a connection cable 7 for connection with the aircraft and provides for quick release functionality during e.g. ejection from the aircraft. The quick release connector 3a also provides the means for normal connection and disconnection of the display system in the aircraft. The man-portion quick release connector 3a is associated with the helmet support unit 3 by means of an extension 3b.

The helmet support unit 3 is attached to the garment 8 of the pilot in a holder 8a specifically adapted for this purpose. In the embodiment disclosed in FIG. 1, the holder 8a is a pocket in the garment of the pilot. The holder may also be a clip, given that the clip may sustain the forces occurring at an ejection from the aircraft. The helmet support unit 3 is preferably attached in such a location on the garment, that the pilot may easily install the unit on the body by himself.

The high-voltage power source present in the helmet support unit 3 generates a substantial amount of heat while converting the low-voltage power of the aircraft to the high-voltage power required by the CRT. The portion of the helmet support unit that rests against the garment 8 of the pilot may include means for cooling or isolating the unit. Tests have been made with distance elements or flanges, which provide an air gap between the unit and the pilot. Other means of isolation or cooling are of course also possible within the scope of the invention. If the garment 8 of the pilot includes the possibility of injecting air into the garment for counteracting G-forces, this functionality may also be used to create an isolating air gap between the helmet support unit and the pilot.

The display system is interconnected with the aircraft by means of a connection cable 7. In the aircraft, an aircraft quick release connector 7a is arranged to interface with the man-portion quick release connector 3a. The connection cable 7 is attached to the bulkhead by means of any suitable type of connector. However, it is preferable that the connection to the bulkhead is such that the separation resistance in this connection is higher than that in the assembled quick release connector 3a, 7a in order to avoid separation in the bulkhead during an ejection maneuver. Separation of the connection cable 7 from the bulkhead would lead to free-hanging cables after ejection, which is considered undesired from a safety point of view. The man-portion quick release connector 3a and the aircraft quick release connector 7a may be arranged as a plug/socket connector held in place by friction. The two connectors 3a, 7a may also include any other type of mechanical means to join the two connectors 3a, 7a when the display system is installed in the aircraft, provided that such mechanical means allows easy separation of the two connectors 3a, 7a.

1. A display system in a fighter aircraft including a helmet mounted display device and a helmet support unit, wherein the helmet mounted display device is arranged to provide information on a visor of the helmet and the helmet support unit is arranged to interconnect the display system with a system computer and a power source in the aircraft, wherein the helmet support unit includes a high voltage power supply and wherein the helmet support unit is arranged in a holder on a garment of the pilot.

2. A display system in accordance with claim 1, wherein the helmet support unit and the helmet mounted display device are integrated by means of a flexible extension and wherein the helmet support unit includes a quick release connector for detachably connecting the helmet support unit to a connector on a connection cable for connection with the aircraft.

3. A display system in accordance with claim 2, wherein the quick release connector is arranged to be released from the connector on the connection cable when subjected to a pulling force exceeding a first predetermined level.

4. A display system in accordance with claim 3, wherein the flexible extension includes an emergency coupling arranged to be disconnected at a pulling force exceeding the first predetermined level at least by a factor of two.

5. A display system in accordance with claim 4, wherein the helmet support unit includes a high-voltage power converter, a graphic editor, and a memory card.

6. A display system in accordance with claim 1, wherein the holder is a front pocket on the torso of the pilot.

7. A display system in accordance with claim 3, wherein the holder is a clip attached to the garment of the pilot.

8. A display system in accordance with claim 1, wherein the helmet support unit includes cooling apparatus in a back portion of the unit, which portion interfaces with the pilot.

9. A display system in accordance with claim 1, wherein the helmet support unit includes isolation apparatus in a back portion of the unit, which portion interfaces with the pilot.

10. An aircraft display system comprising:
a display device operable to display information on a visor of a helmet;
a support unit operable to interconnect the display device with a computer system and a power source, the support unit including a power supply for the display device, and the support unit mountable on a garment of a wearer of the helmet.

11. The display system of claim 10, further comprising:
a flexible extension connecting the support unit and the display device; and
the support unit further includes a quick release connector for detachably connecting the support unit to the aircraft.

12. The display system of claim 11, wherein the quick release connector is arranged to be released when subjected to a pulling force exceeding a first predetermined level.

13. The display system of claim 12, wherein the flexible extension includes an emergency coupling arranged to be disconnected at a pulling force exceeding the first predetermined level at least by a factor of two.

14. The display system of claim 13, wherein power supply is a high-voltage power converter.

15. The display system of claim 14, wherein the helmet support unit further includes a graphic editor and a memory card.

16. The display system of claim 10, wherein the aircraft is a fighter aircraft and the display device is mountable to the helmet.

17. The display system of claim 16, wherein the support unit is mountable using a pocket of the garment.

18. The display system of claim 16, wherein the support unit is mountable using a clip attached to the garment.

19. The display system of claim 10, wherein the support unit further includes a cooling apparatus operable to interface with the wearer of the garment.

20. The display system of claim 10, wherein the support unit further includes an isolation apparatus operable to interface with the wearer of the garment.
